(19) United States
(12) Patent Application Publication
(10) Pub. No.: US 2004/0258389 A1
(43) Pub. Date: Dec. 23, 2004

(54) Pass through mode for a personal video recorder

(76) Inventor: Michael J. Castillo, Hillsboro, OR (US)

Correspondence Address: BUCKLEY, MASCHOFF, TALWALKAR LLC, 5 ELM STREET, NEW CANAAN, CT, 06840, US

(21) Appl. No.: 10/463,651

(22) Filed: Jun. 17, 2003

(51) Int. Cl. H04N 5/76

(52) U.S. Cl. 386/46; 386/111

(57) ABSTRACT

A method, apparatus, and system for outputting a programming signal from a personal video recorder as received and alternately outputting the programming signal after being compressed and uncompressed.

### BACKGROUND

A personal video recorder (PVR) is a consumer electronics device that records and plays television programming. Unlike a VCR that uses removable cassettes for storage of programming, a PVR typically stores programming on an internal hard drive that is similar to the hardware that a personal computer uses to store data.

The PVR can be used to record a specific television programs at a specific time for viewing at a later date and also may be used to record multiple programs from multiple channels. That allows recording of program of one or more particular types, regardless of what channel those programs are on (e.g., all professional football games televised).

The PVR may also use an internal modem or other communication device to periodically communicate with a television program listing database to check the available program listings for the services subscribed to by the owner. One example of a listing update could be a current listing of programs that may be viewed for a fee that shows times those programs will run. Such a listing allows a user to select programs or types of programs desired, facilitating programming of the PVR based upon the preferences of the user available listings.

### BRIEF DESCRIPTION OF THE DRAWINGS

FIG. 1 is a flow diagram of a PVR programming storage and retrieval method;

FIG. 2 is a flow diagram of an embodiment of a PVR method that permits viewing of stored or live programming;

FIG. 3 illustrates an embodiment of a PVR device for processing stored and live programming;

FIG. 4 illustrates an embodiment of a processing module;

FIG. 5 illustrates an embodiment of a peripheral module;

FIG. 6 illustrates an embodiment of a programming reception module; and

FIG. 7 illustrates an embodiment of a programming output module.

### DETAILED DESCRIPTION

The description and figures may include certain elements associated with a PVR while eliminating, for purposes of clarity, other elements found in typical computers and computer networks. Moreover, those of ordinary skill in the art will appreciate that the recording and viewing techniques described in connection with PVRs may be equally applicable to other devices that include certain PVR functionality such as, for example, personal computers, televisions, and DVD players.

The terms “view” or viewing” as used herein indicate watching or listening to programming. Any reference in the specification to “one embodiment,” “a certain embodiment,” or a similar reference to an embodiment is intended to indicate that a particular feature, structure or characteristic described in connection with the embodiment is included in at least one embodiment of the invention. The appearances of such terms in various places in the specification are not necessarily all referring to the same embodiment. References to “or” are furthermore intended as inclusive so “or” may indicate one or another of the ored terms or more than one ored term.

A, broadcaster may transmit video and audio, referred to herein as “programming,” utilizing a six megahertz bandwidth. Because of the large amount of data that may be associated with programming, a home recording device, such as a PVR, may store the programming in a compressed, and consequentially reduced quality, format to reduce the amount of storage space required to less than the amount of data originally broadcast. It should be noted that embodiments of the present programming processing device may be applied to a variety of analog and digital broadcast standards.

Storing programming, whether received from a broadcaster or otherwise, allows a PVR to include various features with which a user can manipulate the programming. For example, a user may view the stored programming at any time convenient to the user. Moreover, the user can perform many functions that are familiar to users of VCRs, such as fast forwarding, rewinding, and pausing.

Some standards for compressing and storing full motion video, and sometimes audio, are associated with the “MPEG,” which stands for Moving Pictures Experts Group. For example, an MPEG2 protocol is defined by International Organization for Standardization (ISO)/International Engineering Consortium (IEC) document number 13818-1 entitled “Information Technology—Generic Coding of Moving Pictures and Associated Audio Information” (2000) and an MPEG4 protocol is defined by ISO/IEC document number 14496-1 entitled “Information Technology—Coding of Audio-Visual Objects” (2001).

A goal of the MPEG standards is to make the storage and transmission of programming more efficient by compressing the data that defines the visual and, in certain standards, audio presentation or programming. MPEG compression techniques deal with ‘frame-based’ video. Frame based video compression interacts with the subject programming at the video frame level and, where applicable, with the audio associated with each of those frames. MPEG2 generally uses fewer techniques than MPEG4 to compress the programming data stream. For example, MPEG2 may compress only the video portion of the programming, while MPEG4 may compress both video and audio portions of the programming.

A method of providing a signal as an output of a personal video recorder is contemplated. That method includes receiving a programming signal, decoding the programming signal, and outputting the decoded programming signal directly without compressing the programming signal. In that method, the programming signal may be available for outputting either from a directly decoded programming signal or from a compressed and uncompressed, and then decoded form of the broadcast signal.

A method of providing both live and stored programming is also contemplated. That method includes receiving a programming signal, storing the programming signal as programming data in a compressed format, and playing a program defined by the programming signal one of directly from the received programming signal and from the stored and compressed programming data.

A programming processing device is also contemplated. The programming processing device includes a first tuner receiving a programming signal, a first input decoder receiving a signal from the first tuner, an encoder that receives a decoded signal from the first input decoder and compresses the decoded signal, a storage device that receives a compressed signal from the encoder and stores the compressed signal, and an output decoder that receives the decoded signal from the first input decoder and the compressed signal from the storage device. The programming processing device may also include at least a second tuner receiving the programming signal, at least a second input decoder receiving a second signal from the second tuner, and a multiplexer receiving the signal from the first decoder and the second signal from the second decoder, wherein the encoder operates on a multiplexed signal from the multiplexer. A codec may also be coupled intermediate each of the input decoders and the multiplexer such that a signal transmitted from each codec is also multiplexed by the multiplexer.

Another programming processing device is also contemplated in another embodiment. The programming processing device includes a processor, memory coupled to the processor, an output decoder coupled to the processor, a data storage device coupled to the output decoder, a video encoder coupled to the output decoder, an input decoder coupled to the video encoder and the output decoder, and a tuner coupled to the input decoder. The programming processing device may include other devices including a multiplexer that may be coupled intermediate the input decoder and the video encoder and coupled to the output decoder. The programming processing device may also include such things as a communication adaptor, a camera, and a digital versatile disk drive coupled to the processor. The programming processing device may also include a codec coupled to the input decoder and the multiplexer and an MPEG encoder coupled intermediate the multiplexer and the output decoder.

An article of manufacture is also contemplated. The article of manufacture includes a computer readable medium having stored thereon instructions which, when executed by a processor, cause the processor to receive a programming signal, decode the programming signal, and output the decoded programming signal directly without compressing the programming signal. The article of manufacture may also cause the processor to output the programming signal in a compressed, stored, and uncompressed form when a user chooses to watch previously received programming and may cause the processor to output the decoded programming signal directly without compressing the programming signal when a user chooses to watch programming as it is received.

An embodiment of the present stored and live programming invention includes a programming system. The programming system includes a program transmitting processor and a program receiving processor coupled to the program transmitting processor. The program receiving processor receives a program signal transmitted from the program transmitting processor. The program receiving processor compresses the program signal and may store the compressed signal for later viewing. The program receiving processor outputs one of an uncompressed signal corresponding to the compressed program signal and a signal corresponding directly to the program signal received. A scheduling processor may also be coupled to the program receiving processor. The scheduling processor may transmit broadcast programming schedule information to the program receiving processor.

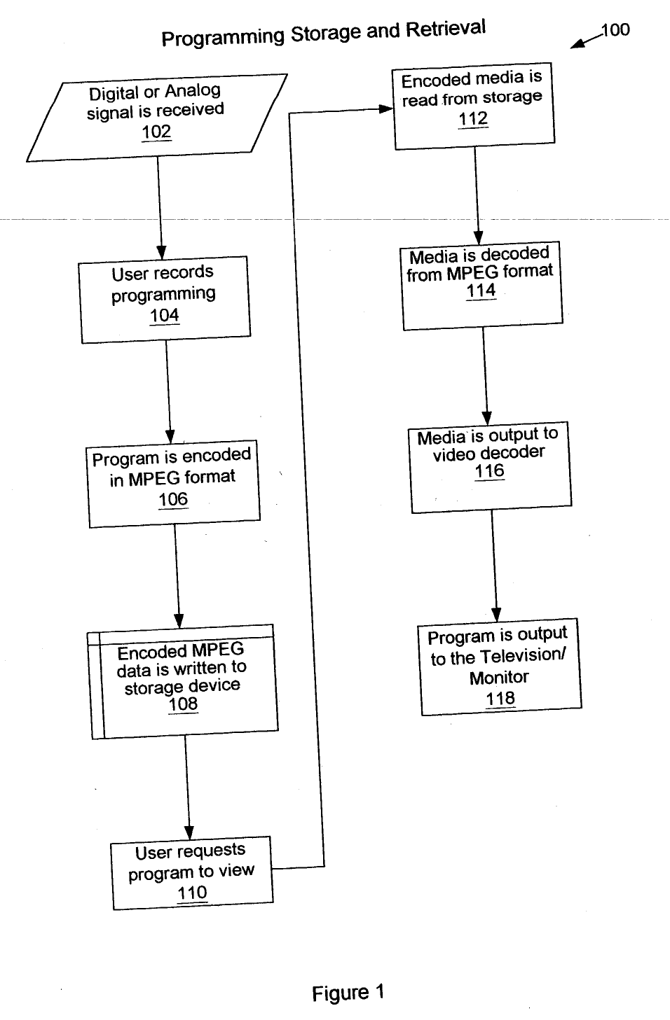

FIG. 1 illustrates an embodiment of a storage and retrieval method 100 in which programming is stored by a PVR and then viewed through the PVR from the storage medium. At 102, a programming signal is received by the PVR. That signal may be in a variety of digital or analog formats.

The user of the PVR makes a decision to record programming at 104. The programming to be recorded may be selected in a variety of ways including programming the PVR to record a particular program, a program appearing on a particular channel at a particular time, or types of programs to be selected, for example, from a program listing database.

At 106, the program is encoded in MPEG format, which also compresses the programming data. The encoded programming is then stored in a storage device at 108. The storage device may, for example, be a magnetic disk (e.g., floppy disk and hard drive), optical disk (e.g., CD-ROM) or any other device or signal that can store digital information.

At 110, the user selects a program that has been stored and requests to view that program. At 112, the encoded programming data, or media, representing the program is read from storage and the program media is decoded from MPEG format at 114.

The program selected for viewing could be a program that is currently being encoded and stored and immediately read from storage or could be a program that was previously stored. In some devices, that program could not be viewed directly but may only be viewed from the storage device. Embodiments of the present recording and viewing device and method, however, permit selection of viewing from either storage or a direct feed of the programming signal being received from a broadcaster.

At 116, the decoded programming data is output to an output decoder, and at 118 the selected program is output to a television or monitor.

A user may interact with the media through the PVR. That interaction may include functions such as pause, stop, rewind, and fast forward. When a pause or stop type function is selected, media may stop being read from storage and decoded in an embodiment wherein a live feed is not available for output directly. When a reverse or fast forward type function is selected, the point in the programming at which media is read and decoded may change and when a play type function is selected, the media may again be read from storage and decoded at the newly selected point where the live feed is not directly available for output.

When the live feed is not directly available for output, a degradation in quality of the programming may be noticeable to a human viewer, which is caused by the encoding and compressing and decoding and uncompressing process. MPEG, for example, provides varying levels of compression when encoding programming data, with reduced compression generally providing a better quality program. In any MPEG encoding, however, there is significant compression of the programming data. Thus, a degree of degradation is normal anytime programming data is encoded. That degradation will exist even when a user wishes to view the program as it is received if all programming is stored and retrieved from storage before being output for viewing.

In some embodiments, programming signals in two streams are handled simultaneously through a PVR. The first stream is a compressed, stored, and then uncompressed version of the programming signal, while the second stream uses the programming stream directly. For the second, direct programming stream, the PVR may receive the programming signal, decode that signal and output the decoded programming signal. Either of those streams may then be selected for decoding and outputting to a television or monitor.

In some embodiments, a user may select either to view a live programming signal received directly from, for example, a broadcaster or the stored media. Thus, the programming signal received by the PVR may be directed to both a storage device and directly to the output decoder. The user may then interact with the PVR to directly or indirectly select to view either the live broadcast programming signal or the stored data. The PVR will then direct either the live broadcast signal or the stored data to a television or monitor depending on the user's selection. For example, the PVR may output the live broadcast signal when a user is viewing the output of the personal video recorder as the broadcast signal is received and the personal video recorder will output the compressed, stored, and uncompressed signal when the user of the personal video recorder is viewing the output of the personal video recorder after the broadcast signal was received.

Thus, if the user selects to view a program as a broadcast is received, the live broadcast will be directed to the television or monitor, whereas if the viewer selects to view previously received programming, the stored program data will be retrieved and directed to the television or monitor.

For example, if a user elects to play a program that is currently being received by the PVR, the PVR may direct the live broadcast to the television or monitor. If the user then elects to pause the program, the last displayed frame may be continuously output to the television or monitor by the PVR. If the user next elects to play the program, the PVR may direct the program to the television or monitor from the stored data, and the program may proceed from the point at which the program was paused. If the user then fast forwards the program to a point at which the live broadcast is being received, the PVR may again direct the live broadcast to the television or monitor. In that way, the PVR may provide the live broadcast to the television or monitor when that broadcast is being viewed at the same time it is received and the PVR may provide the compressed, stored, and uncompressed program data to the television or monitor when that broadcast is being viewed after it is received. Switching between live and compressed program signals may be handled seamlessly using time stamps that are present in an MPEG encoded data stream to synchronize the transition.

An advantage of viewing a live broadcast directly rather than from the stored program data is that the quality of a video, and sometimes audio, from a live broadcast is usually higher than the quality of video and audio that has been compressed. Such compression typically occurs when programming is encoded, stored as program data, and then uncompressed from the compressed and stored program data. That compressed program data is furthermore typically a lesser amount of data than the original programming, and as such, is a lower quality representation of the programming.

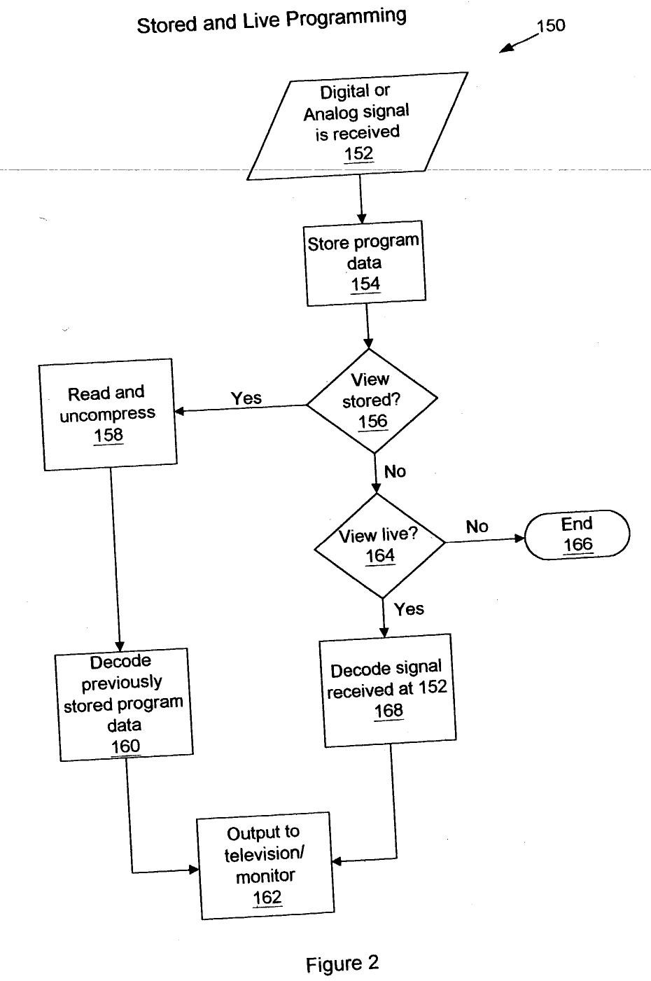

FIG. 2 illustrates an embodiment of a stored and live programming method 150 in which programming is stored by a PVR and may be viewed through the PVR live, directly from the programming signal, or from the storage medium. In this case, a digital or analog signal is received at 152. At 154, the programming signal, which may be a broadcast signal, is stored to a storage device. The process of storing to a storage device may include, for example, the program encoding and writing to a storage device illustrated and discussed in connection with 106-108 of FIG. 1.

At 156, if the user selects a function that causes the PVR to output a signal other than the signal currently being received, a signal that was previously received at 152 and stored as program data at 154, then the PVR will read and uncompress the stored programming data at 158. That reading and uncompressing may be performed as illustrated and discussed in connection with 112-114 of FIG. 1. The uncompressed program data is then decoded at 160 and output to a television or monitor at 162.

If, at 156, the user does not select a function that causes the PVR to output a signal other than the signal currently being received, then the user may select a function that causes the PVR to output the real time, live signal as it is received by the PVR at 164. If the user selects no viewing function, then no signal is output to the television or monitor, as indicated at 166. If, however, the user selects a function that causes the PVR to output the live signal, then that live programming data will be decoded at 168 and sent to the television or monitor at 162. It should be recognized that a user may make selections through the PVR at various times that will cause the PVR to alternate between outputting the direct programming signal and the compressed, stored, and uncompressed media.

A programming processing device for processing stored and live programming is also contemplated. In an embodiment, that device includes a tuner that receives a programming signal from, for example, a broadcast. The signal is then transmitted from the tuner to a decoder and the decoded signal may be transmitted to a multiplexer where desired. From the decoder or multiplexer, the signal takes two concurrent paths. In the first of those paths, the signal proceeds through an encoder, where it is compressed. The compressed signal is then stored in a storage device and made available in compressed format to a decoder. In the second of those paths, the signal is transmitted directly from the decoder or multiplexer to the output decoder. One of those two compressed or uncompressed signals is then selected to be output to a viewing device such as a television or monitor.

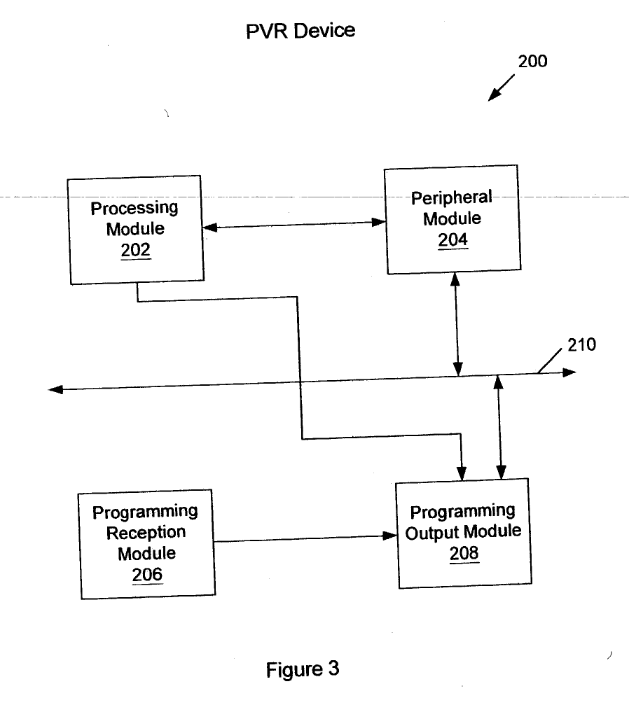

FIG. 3 illustrates an embodiment of a PVR device for processing stored and live programming 200. That PVR device for processing stored and live programming 200 includes a processing module 202, a peripheral module 204, a programming reception module 206, and a programming output module 208.

Certain elements of the PVR device 200 may communicate with each other by way of one or more communication busses 210 as shown by arrows from those elements to those busses 210. Those busses 210 may include, for example, a system bus, a peripheral component interface (“PCI”) bus, or an industry standard architecture (“ISA”) bus.

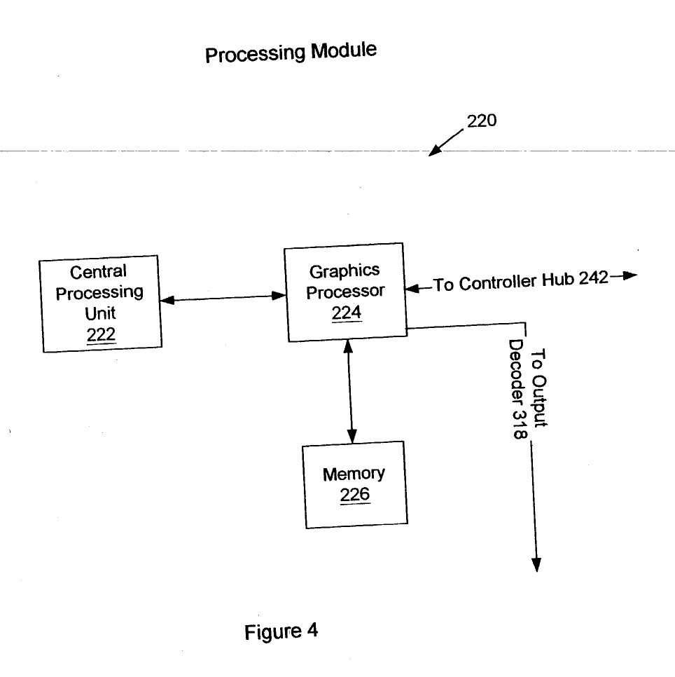

FIG. 4 illustrates processing module components 220 that form the processing module 202 of FIG. 3 in an embodiment. That embodiment of the processing module 202 includes a central processing unit 222 coupled to a graphics processor 224, which is in turn coupled to memory 226. The central processing unit 222 executes instructions that cause the central processing unit 222 to perform logical, computational, and decision-making functions of the PVR device 200.

The central processing unit 222 may, for example, be an Intel® Pentium® type processor or another processor manufactured by, for example Motorola®, Compaq®, AMD®, or Sun Microsystems®. The central processing unit 222 may furthermore execute the program instructions and process the data stored in the memory 226. In one embodiment, the instructions are stored in memory 226 in a compressed and/or encrypted format. As used herein the phrase, “executed by a processor” is intended to encompass instructions stored in a compressed and/or encrypted format, as well as instructions that may be compiled or installed by an installer before being executed by the processor.

The graphics processor 224 provides computational processing required for graphics. Instructions and data required for processing programming may be stored in the memory 226. The graphics processor 224 may, for example, be an 82830 Graphics and Memory Controller Hub manufactured by Intel®.

The memory 226 may, for example, include random access memory (RAM), dynamic RAM, and/or read only memory (ROM) (e.g., programmable ROM, erasable programmable ROM, or electronically erasable programmable ROM) and may store computer program instructions or information. The memory 226 may furthermore be partitioned into sections including an operating system partition in which operating system instructions are stored, and a data partition in which data is stored.

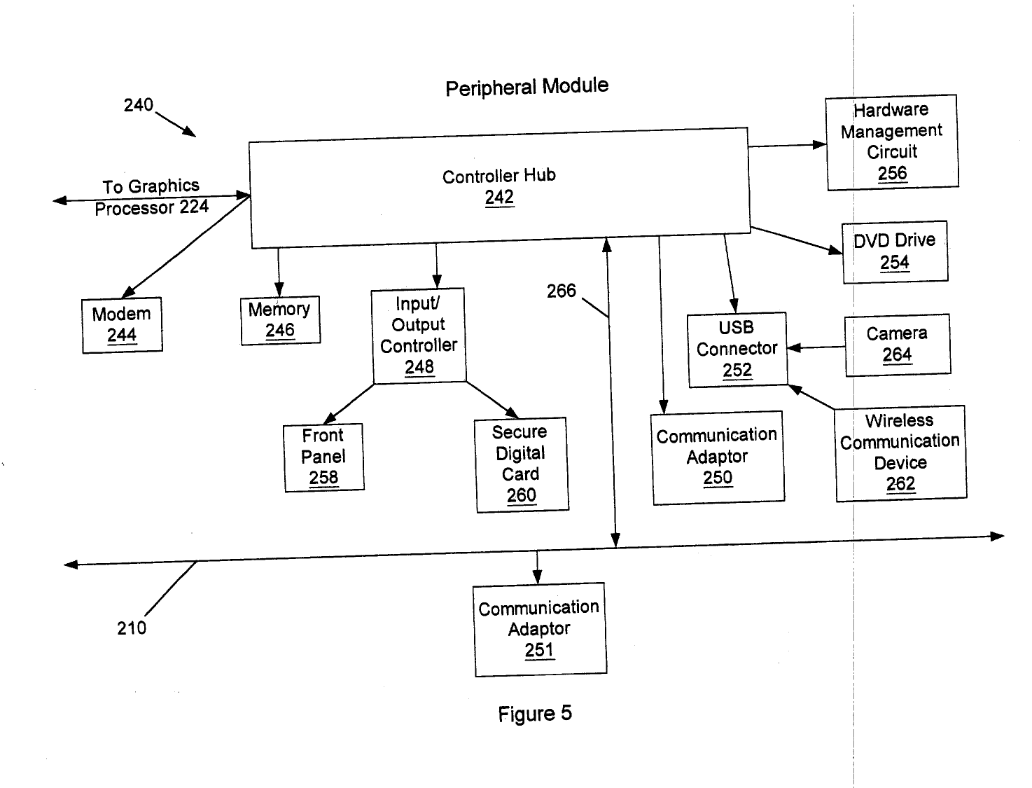

FIG. 5 illustrates peripheral module components 240 that form the peripheral module 204 of FIG. 3 in an embodiment. That embodiment of the peripheral module 204 includes a controller hub 242 coupled to the graphics processor 224, a modem 244, memory 246, an input/output controller 248, a communication adaptor 250, a USB connector 252, a DVD drive 254, and a hardware management circuit 256. The controller hub 242 and the components coupled thereto are optional and provide connectivity to accessories if desired. The controller hub 242 may be, for example, an 82801DB I/O Controller Hub 4, manufactured by Intel®, and may have input and output capability for linking various components to the graphics processor 224 or to the internal busses 210.

The modem 244 may be coupled to the controller hub 242 by way of wire or through a wireless connection. The modem 244 may be used to transmit or receive data, such as programming data, over a telephone wire. The memory 246 may be any type of memory including, for example, bios flash memory. That memory 246 may be used to store data or instructions received by or transmitted from the controller hub 242.

The input/output controller 248 permits communication with a front panel 258 or a secure digital card reader 260. The front panel 258 may provide indicators and switches such as, for example, a power indicator and a power switch. The secure digital card reader 260 may allow the use of secure digital memory cards that store audio or video data.

The communication adaptor 250 permits communication between the PVR device 200 and other devices or nodes coupled to the communication adaptor 250. The communication adaptor 250 may be a network interface that transfers information from nodes on a network to the PVR device 200 or from the PVR device 200 to nodes on a network. The network may be, for example, a local area network or a wide area network. A second communication adaptor 251 may alternately or in addition be coupled directly to the busses 210.

The USB connector 252 permits coupling of devices that couple to USB connectors to the controller hub 242. A wireless communication device 262, such as a Bluetooth® device is illustrated as being coupled to the USB connector 252 in this example. That wireless communication device 262 may, for example, permit program data to be passed to the PVR device 200 through the controller hub 242 from a remote device. A camera 264 is also illustrated as being coupled to the USB connector 252 to permit program data contained in the camera 264 to be transferred to the PVR device 200.

A digital versatile disk (“DVD”) drive 254 is illustrated as being coupled to the controller hub 242 to provide program data to the PVR device 200 through the controller hub 242. The hardware management circuit 256 illustrated in FIG. 5 is coupled to the controller hub 242 to monitor the operability of the hardware using, for example, sensors to monitor temperature, fan operation, voltage fluctuations, or other hardware activity to assure the functionality of the hardware coupled to the PVR device 200. The controller hub 242 may also be coupled to the busses 210 at 266 to communicate with other devices coupled thereto.

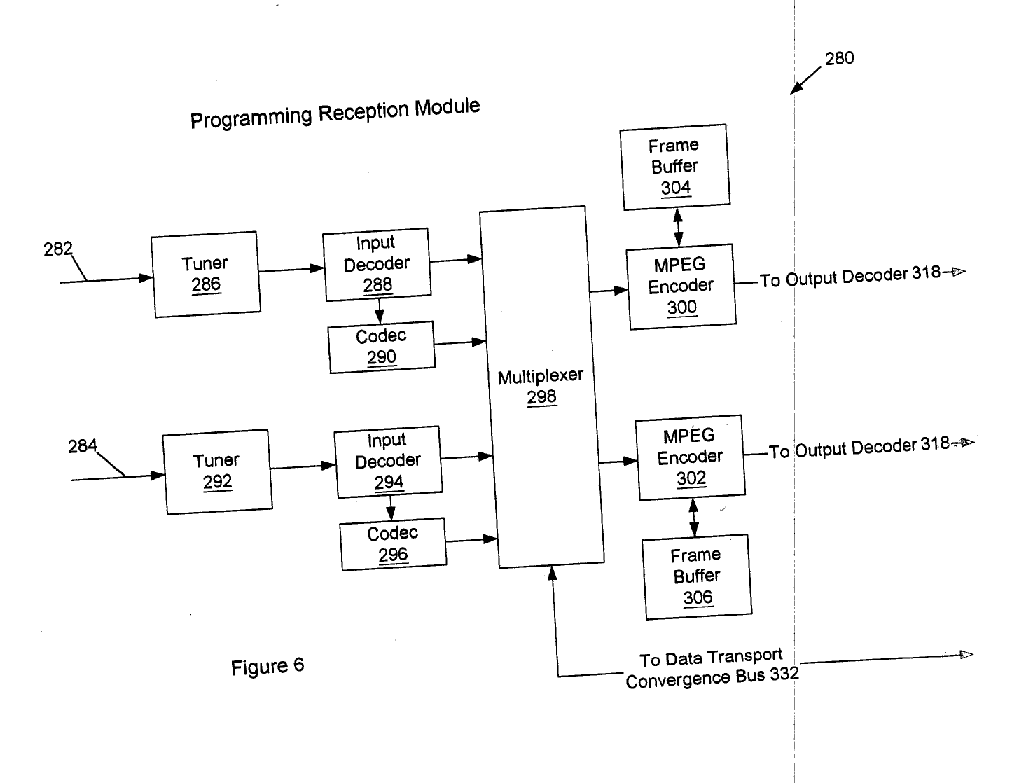

FIG. 6 illustrates programming reception components 280 included in an embodiment of the programming reception module 206. In that embodiment, the programming reception module 206 includes a first input circuit 282 and a second input circuit 284. The first input circuit 282 includes a tuner 286, an input decoder 288, and a codec 290. The second input circuit also includes a tuner 292, an input decoder 294, and a codec 296.

The tuners 286 and 292 may be analog tuners or digital tuners such as, for example tuner model TSCH6, manufactured by Alps® Electric (USA), Inc. Those tuners may be utilized to receive programming signals including broadcast signals. The input decoders 288 and 294 convert the broadcast signals into PVR useable formats. Those input decoders 288 and 294 may be, for example, Philips® model SAA7118 decoders. The codecs 290 and 296 convert analog signals into digital signals and may be used to convert analog sound signals into digital sound signals where the broadcast being received is analog. The codecs 290 and 296 may include, for example, Philips® model TDA9851 and UDA1342TS components.

The multiplexer 298 receives signals from the input decoders 288 and 294 and codecs 290 and 296 and directs a multiplexed signal to at least one video encoder such as MPEG encoder 300 or 302 or an output decoder 318. The multiplexer 298 may be, for example, a model QS4A201 QuickSwitch manufactured by IDT®. The MPEG encoders 300 and 302 receive the multiplexed signal and compress the video signal and, sometimes, the audio signal received depending on the desired MPEG format utilized. The MPEG encoders 300 and 302 may be, for example, model uPD61151 encoders manufactured by NEC®. The frame buffers 304 and 306 may include memory for temporary storage of data being processed by the MPEG encoders 300 and 302.

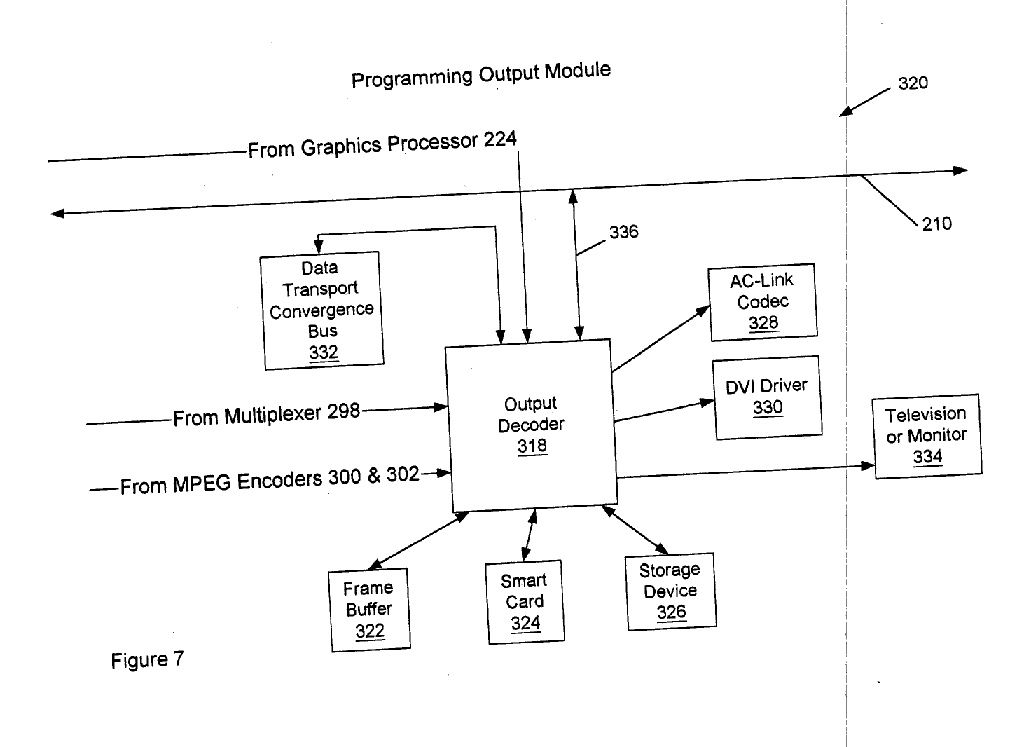

FIG. 7 illustrates programming output components 320 included in an embodiment of the programming output module 208. In that embodiment, the programming output module 208 includes an output decoder 318 receiving programming signals from the MPEG encoders 300 and 302 and the multiplexer 298. In this embodiment, the output decoder 318 is also coupled to a variety of other devices including a frame buffer 322, a smart card 324, a storage device 326, an AC-link codec 328, a DVI driver 330, a high performance serial device 332, and a television or monitor 334. The output decoder 318 may also be coupled to the busses 210 at 336 for communication with other devices where desired.

The output decoder 318 may be coupled to the peripheral module 204 and may operate in accordance with instructions received from the peripheral module 204. The output decoder 318 may be selected or programmed to provide a variety of signals including, for example, S-Video, composite video, digital video interface (“DVI”), or YP_{R}P_{B} signals, YP_{R}P_{B} signals being capable of being used with component video and transferring high definition content over an analog bus.

The output decoder frame buffer 322 provides memory for temporary storage of data being processed by the output decoder 318. The smart card 324 may, for example, be used to store encryption keys used by the output decoder 318 to decrypt encrypted programming. The storage device 326 is provided to store compressed programming for future viewing. The AC-link codec 328 may be, for example, a Model STAC9756 manufactured by SigmaTel® and may be used, for example, to play audio programming stored in the PVR device. The DVI driver 330 may be utilized where digital video output from the output decoder 318 is desired to be sent to a device utilizing a high definition multimedia interface. Such DVI devices might include, for example, DVD players, digital televisions, and set-top boxes. The DVI driver 330 may be, for example, a model SII170, manufactured by Silicon Images®. The high performance serial bus332 may be, for example, a FireWire®, manufactured by Apple®, or an I.LINK®, manufactured by Sony® and may be coupled to the output decoder 318 and multiplexer 298 to facilitate streaming of content between the PVR device 200 and another device.

The television or monitor 334 receives a signal output from the output decoder 318, which may be either the compressed, stored, and uncompressed signal coming from the MPEG encoders 300 and 302 or the live signal that bypasses the MPEG encoders 300 and 302. Other devices, such as the AC-link codec 328 and DVI driver 330, may also or alternately receive either the compressed, stored, and uncompressed signal coming from the MPEG encoders 300 and 302 or the live signal that bypasses the MPEG encoders 300 and 302. The television or monitor 334 may then display the video associated with the received signal.

An article of manufacture is also contemplated. That article of manufacture includes a computer readable medium having stored thereon instructions that may be executed by a processor. Those instructions cause the processor to receive a programming signal, decode the programming signal, and output the decoded programming signal directly without compressing the programming signal. The article of manufacture may also provide a second programming output signal that has been compressed, stored, and uncompressed. A user of the processor executing those instructions may then select output of either the direct programming signal or the compressed, stored, and uncompressed programming signal.

The several embodiments described herein are solely for the purpose of illustration. Persons skilled in the art will recognize from this description other embodiments may be practiced with modifications and alterations limited only by the claims.

What is claimed is:

1. A method, comprising:
receiving a programming signal at a personal video recorder;
decoding the programming signal; and
outputting the decoded programming signal directly without compressing the programming signal.

2. The method of claim 1, wherein the programming signal is available for outputting either from a directly decoded programming signal or from a compressed, uncompressed, and decoded programming signal.

3. The method of claim 2, further comprising receiving a user selection to view either the direct programming signal or the compressed, uncompressed, and decoded programming signal.

4. The method of claim 2, wherein the personal video recorder outputs the directly decoded programming signal when a user of the personal video recorder is viewing the output of the personal video recorder as the programming signal is received and wherein the personal video recorder outputs the compressed, uncompressed, and decoded programming signal when the user of the personal video recorder is viewing the output of the personal video recorder after the programming signal was received.

5. The method of claim 1, further comprising transmitting the output signal to a viewing device.

6. A programming processing device, comprising:
a first tuner to receive a programming signal;
a first input decoder to receive a signal from the first tuner;
an encoder to receive a decoded signal from the first input decoder and compress the decoded signal;
a storage device to receive a compressed signal from the encoder and store the compressed signal; and
an output decoder that receives the decoded signal from the first input decoder and the compressed signal from the storage device.

7. The programming processing device of claim 6, further comprising:
a second tuner to receive the programming signal;
a second input decoder to receive a second signal from the second tuner; and
a multiplexer to receive the signal from the first decoder and the second signal from the second decoder, wherein the encoder is to operate on a multiplexed signal from the multiplexer.

8. The programming processing device of claim 6, further comprising a monitor to receive a display signal from the output decoder and display the video associated with the display signal.

9. The programming processing device of claim 6, further comprising a television to receive a display signal from the output decoder and display the video associated with the display signal.

10. The programming processing device of claim 6, wherein the output decoder is to output a signal decoded from the first input decoder signal when a user selects to watch the programming signal as it is received and wherein the output decoder is output a signal decoded from the compressed signal when the user selects to watch programming that was previously received.

11. An article of manufacture comprising:
a computer readable medium having stored thereon instructions which, when executed by a processor, cause the processor to:
receive a programming signal at a personal video recorder;
decode the programming signal; and
output the decoded programming signal directly without compressing the programming signal.

12. The article of manufacture of claim 11, wherein the instructions furthermore cause the processor to output the programming signal in a compressed, uncompressed, and decoded form in addition to the directly decoded signal form.

13. The article of manufacture of claim 12, wherein the instructions cause the processor to output the decoded programming signal directly without compressing the programming signal when a user chooses to watch the programming as it is received and cause the processor to output the programming signal in a compressed, stored, and uncompressed form when the user chooses to watch previously received programming.

14. A method of providing both live and stored programming, comprising:
receiving a programming signal;
storing the programming signal as programming data in a compressed format; and
playing a program defined by one of the received programming signal and the stored programming data.

15. The method of claim 14, wherein said playing a program includes:
playing the program directly from the received programming signal when a signal currently being received is selected; and
playing the program from the stored programming data when a signal other than the signal currently being received is selected.

16. A programming processing device, comprising:
a processor;
memory coupled to the processor;
an output decoder coupled to the processor;
a data storage device coupled to the output decoder;
a video encoder coupled to the output decoder;
an input decoder coupled to the video encoder and the output decoder; and
a tuner coupled to the input decoder.

17. The programming processing device of claim 16, further comprising a multiplexer coupled intermediate the input decoder and the video encoder and coupled to the output decoder.

18. The programming processing device of claim 16, further comprising a communication adaptor coupled to the processor.

19. The programming processing device of claim 16, further comprising a camera coupled to the processor.

20. The programming processing device of claim 16, further comprising a digital versatile disk drive coupled to the processor.

21. The programming processing device of claim 16, further comprising:
a codec coupled to the input decoder;
a multiplexer coupled to the codec and intermediate the input decoder and the output decoder; and
an MPEG encoder coupled intermediate the multiplexer and the output decoder.

22. A programming system, comprising
a program transmitting processor to transmit a program signal; and
a program receiving processor coupled to the program transmitting processor to receive the program signal from the program transmitting processor, compress the program signal, and output one of an uncompressed signal corresponding to the compressed program signal and a signal corresponding directly to the program signal received.

23. The programming system of claim 22, further comprising a scheduling processor coupled to the program receiving processor to transmit broadcast programming schedule information to the program receiving processor.

24. The programming system of claim 22, wherein the program receiving processor is to output the uncompressed signal corresponding to the compressed program signal when outputting previously received programming and to output the signal corresponding directly to the program signal received when outputting programming concurrently with its receipt.
